(19) United States
(12) Patent Application Publication
(10) Pub. No.: US 2021/0240277 A1
(43) Pub. Date: Aug. 5, 2021

(54) Systems, Methods and Computer Programs for Method for Determining Information on a Feedback to a Stimulus

(71) Applicant: Bayerische Motoren Werke Aktiengesellschaft, Munich (DE)

(72) Inventor: Etienne ILIFFE-MOON, Menlo Park, CA (US)

(21) Appl. No.: 16/782,153

(22) Filed: Feb. 5, 2020

(51) Int. Cl. G06F 3/01; G06K 9/00; G06N 20/00

(52) U.S. Cl. CPC G06F 3/017; G06K 9/00315; G06N 20/00; G06F 3/012; G06K 9/00832; G06K 9/00335

(57) ABSTRACT

Examples relate to systems, methods and computer programs for method for determining information on a feedback to a stimulus, e.g. to a stimulus within a vehicle. The system comprises one or more processors and one or more storage devices. The system is configured to obtain visual sensor data from an optical sensor of the vehicle. The visual sensor data depicts at least a face of a user of the vehicle. The system is configured to process the visual sensor data to detect one of a plurality of pre-defined gestural expressions within the visual sensor data. The system is configured to provide a display control signal to a display of the vehicle, to cause the display to show a visual representation of the detected gestural expression. The system is configured to determine the information on the feedback to the stimulus based on the detected gestural expression.

### FIELD

Examples relate to systems, methods and computer programs for determining information on a feedback to a stimulus, more precisely, but not exclusively, to the use of gesture detection to provide feedback on a stimulus.

### BACKGROUND

In modern vehicles, a plethora of different stimuli are used to provide a pleasurable experience for the passengers of the vehicle, while retaining or improving a safety of the vehicle, e.g. by shielding the driver from distractions while still providing a pleasurable experience. In some vehicles, these stimuli can be automatically adjusted, e.g. based on the conditions of the road, time of day, driving style etc., to support the passengers in the current situation. In some systems, these adaptations are based on experience or design choices of the manufacturer of the vehicle, which may or may not fit the requirements of the passengers. As experiences become more complex and engage multiple senses, systems may be desired that are more intelligent, in order to deliver experiences that fit the respective users. These systems may use intelligence to analyze and evaluate the user's context to make smart decisions, recommendations and generate experiences. Enabling users (i.e. passengers) to provide feedback to a system on an experience or a preference related to an experience, without disrupting the experience can be a challenge.

### SUMMARY

There may be a desire for gathering feedback on an experience as received and perceived by the user, which is unobtrusive and non-disruptive.

This desire is addressed by the subject-matter of the independent claims.

Embodiments of the present disclosure are based on the finding that giving feedback on a stimulus in a vehicular context should have the aim of not breaking the concentration of a driver, or of other passengers of the vehicle, in order to lower the bar for collecting the feedback while retaining the safety of operation of the vehicle. Embodiments of the present disclosure use the analysis of visual sensor data to detect one of a plurality of pre-defined gestural expressions of a user of the vehicle, and use this gestural expression to determine the feedback. In various embodiments, this may not require active participation of the user, as the gestural expression is most likely performed in response to the stimulus, and not in response to the opportunity for feedback on the stimulus. The detected gestural expression is, however, presented to the user, to make the user aware that the gestural expression is being analyzed and used for feedback, providing the user with a means for actively providing targeted feedback, which may increase the dependability of the feedback derived from the gestural expression.

Embodiments of the present disclosure provide a system for determining information on a feedback to a stimulus within a vehicle. The system comprises one or more processors and one or more storage devices. The system is configured to obtain visual sensor data from an optical sensor of the vehicle. The visual sensor data depicts at least a face of a user of the vehicle. The system is configured to process the visual sensor data to detect one of a plurality of pre-defined gestural expressions within the visual sensor data. The system is configured to provide a display control signal to a display of the vehicle, to cause the display to show a visual representation of the detected gestural expression. The system is configured to determine the information on the feedback to the stimulus based on the detected gestural expression. By displaying the visual representation of the detected gestural expression, the user is made aware of feedback being collected, enabling them to provide targeted feedback. By determining the feedback based on the gestural expression, a distraction of the user by the feedback-giving may be avoided to reduced.

In various embodiments, the stimulus occurs at a point in time. The display control signal may be provided such that the visual representation of the detected gestural expression is shown during a pre-defined period of time relative to the point in time. Thus, a temporal relationship between the feedback-giving and the stimulus may be established, providing a comprehensible link between the two.

For example, the stimulus may occur at a point in time. The information on the feedback to the stimulus may be determined based on the detected gestural expression that is based on visual sensor data of a pre-defined period of time relative to the point in time. Again, a temporal relationship between the feedback-giving and the stimulus may be established, providing a comprehensible link between the two.

In at least some embodiments, the system may be configured to provide a prompt to the user via an output device of the vehicle (or, more general, device, if embodiments are used with devices other than vehicles), the prompt inviting the user to provide gestural feedback in response to the stimulus. This may signal the opportunity of providing feedback to the user. For example, the display of the visual representation of the detected gestural expression may be used as prompt inviting the user to provide gestural feedback.

For example, the prompt may be provided such, that the prompt to provide gestural feedback is perceptible during a pre-defined period relative to a point in time the stimulus occurs at, which may provide a temporal link between the prompt and the stimulus. For example, the prompt may be provided to the user via at least one of a display, a sound device, a haptic or tactile output device and a lighting system of the vehicle.

In various embodiments, the system may be configured to select one of a plurality of output devices for the prompt based on a type of the stimulus. Additionally or alternatively, the system may be configured to generate a representation of the stimulus, and to provide the prompt with the representation of the stimulus to the user. This may establish a relationship between the stimulus type (modality, format, style, design, etc.) and the prompt type (modality, format, style, design, etc.).

The system may be configured to monitor a response of the user to the prompt by processing the visual sensor data, and to repeat the prompt using another output device in case of a lack of a response. This may avoid a misinterpretation of a gestural expression in case the gestural expression was not meant to convey feedback.

In at least some embodiments, the system may be configured to process the visual sensor data before the stimulus occurs to determine a base-line gestural expression of the user. The system may be configured to determine the information on the feedback to the stimulus relative to the base-line gestural expression of the user. This may help provide more accurate feedback, as different users have different base-line gestural expressions.

The visual representation may be based on one of an avatar of the user, an emoji and a visual icon. These abstract representations of the gestural expression may provide a mirror for the gestural expressions performed by the user, making the user aware of the gestural expression that is being used for the feedback.

In some embodiments, the detected gestural expression may be shown as a position on a scale. This may provide a logical link between different gestural expressions, such as smiling, frowning, surprise etc. and a numeric value being used as feedback for the stimulus.

In some embodiments, the system may be configured to generate and/or control the stimulus/stimuli. Accordingly, the system may be configured to provide a control signal to a stimulus generation device of the vehicle, in order to trigger or adjust the stimulus or stimuli. The system may be configured to determine the information on the feedback to the stimulus after triggering or adjusting the stimulus or stimuli. For example, the feedback may be used to adapt the stimulus being provided.

For example, the stimulus may be one of an auditory stimulus, a visual stimulus, an olfactory stimulus, a tactile or haptic stimulus and a vehicle climate stimulus. The stimulus may comprise two or more distinctive components. This may enable complex experiences comprising multiple stimuli, and giving feedback on the same.

In various embodiments, the system may be configured to monitor a response of the user to the stimulus via the visual sensor data, and to determine the information on the feedback to the stimulus if a response to the stimulus is discernible. Thus, gestural expressions that do not seem to relate to feedback may be ignored.

The system may be configured to monitor one or more further physical indicators of the user's body within the visual sensor data or within additional sensor data. The system may be configured to determine the information on the feedback to the stimulus based on the monitored one or more further physical indicators. In addition to the gestural expressions, additional physical markers, such as heart rate, behavior etc. may be used to derive the feedback.

In various embodiments, the system is configured to train a machine-learning model using information on the stimulus as a training input and the information on the feedback as a desired output of the machine-learning model, such that the machine-learning model is suitable for predicting the information on the feedback for a given stimulus. The machine-learning model may thus be used to pre-evaluate the stimuli being provided, leading to a selection of stimuli that are likely to receive a favorable feedback from the user.

Embodiments of the present disclosure further provide a corresponding method for determining information on a feedback to a stimulus within a vehicle. The method comprises obtaining visual sensor data from an optical sensor of the vehicle. The visual sensor data depicts at least a face of a user of the vehicle. The method comprises processing the visual sensor data to detect one of a plurality of pre-defined gestural expressions within the visual sensor data. The method comprises providing a display control signal to a display of the vehicle, to cause the display to show a visual representation of the detected gestural expression. The method comprises determining the information on the feedback to the stimulus based on the detected gestural expression.

While the concept has been introduced for a vehicular setting, the same concept may also be used to in other settings, such as televisions, set-top boxes, home cinema applications, mobile devices, fitness trackers, massage devices etc. Thus, in more generic terms, embodiments further provide a system for determining information on a feedback to a stimulus provided by a device. The system comprises one or more processors and one or more storage devices. The system is configured to obtain visual sensor data from an optical sensor of the device. The visual sensor data depicts at least a face of a user of the device. The system is configured to process the visual sensor data to detect one of a plurality of pre-defined gestural expressions within the visual sensor data. The system is configured to provide a display control signal to a display of the device, to cause the display to show a visual representation of the detected gestural expression. The system is configured to determine the information on the feedback to the stimulus based on the detected gestural expression.

Embodiments further provide a corresponding method for determining information on a feedback to a stimulus provided by a device. The method comprises obtaining visual sensor data from an optical sensor of the device. The visual sensor data depicts at least a face of a user of the device. The method comprises processing the visual sensor data to detect one of a plurality of pre-defined gestural expressions within the visual sensor data. The method comprises providing a display control signal to a display of the device, to cause the display to show a visual representation of the detected gestural expression. The method comprises determining the information on the feedback to the stimulus based on the detected gestural expression.

Embodiments of the present disclosure further provide a computer program product comprising a computer readable medium having computer readable program code embodied therein, the computer readable program code being configured to implement one of the above methods, when being loaded on a computer, a processor, or a programmable hardware component

### BRIEF DESCRIPTION OF THE FIGURES

Some examples of apparatuses and/or methods will be described in the following by way of example only, and with reference to the accompanying figures, in which

FIGS. 1a and 1b show block diagrams of embodiments of a system for determining information on a feedback to a stimulus, and of a device or vehicle comprising such a system;

FIG. 1c shows a flow chart of an embodiment of a method for determining information on a feedback to a stimulus;

FIGS. 2a and 2b show exemplary visual representations of a gestural expression of a user; and

FIGS. 3a and 3b show an example of a determination of information on a feedback to a scent-based stimulus.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

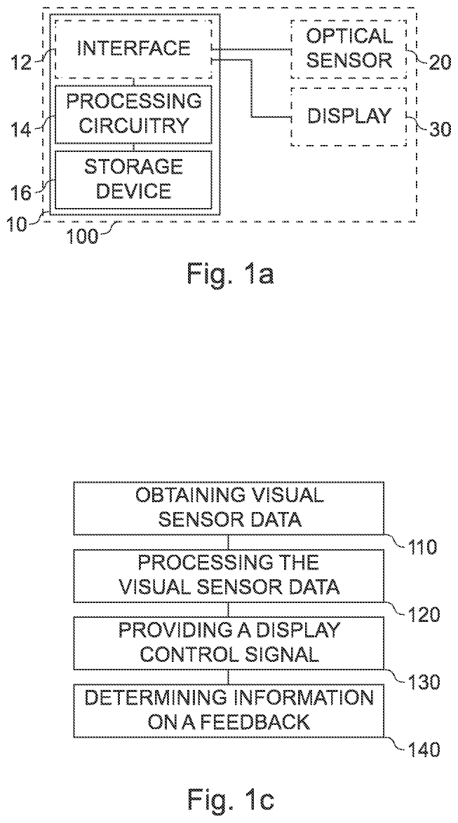

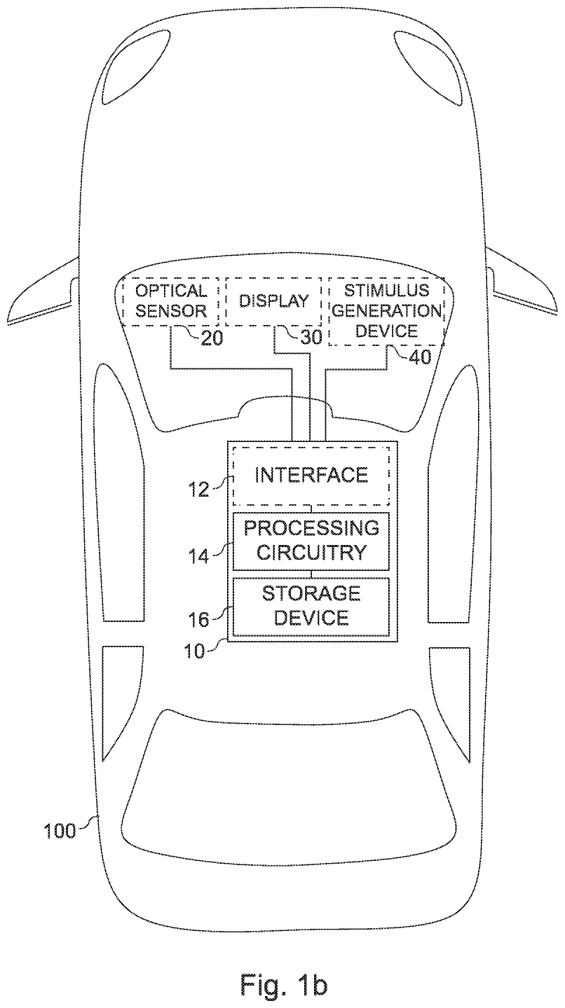

FIGS. 1a and 1b show block diagrams of embodiments of a system 10 for determining information on a feedback to a stimulus (within a vehicle, or originating from the device), and of a device or vehicle 100 comprising such a system. The system comprises one or more processors 14 and one or more storage devices 16. Optionally, the system 10 comprises an interface 12. The one or more processors 14 are coupled to the interface 12 and to the one or more storage devices. In general, the one or more processors 14 may be configured to provide the functionality of the system 10, e.g. in conjunction with the interface 12 and/or the one or more storage devices 16.

The system is configured to obtain visual sensor data from an optical sensor 20 of the vehicle. The visual sensor data depicts at least a face of a user of the vehicle. The system is configured to process the visual sensor data to detect one of a plurality of pre-defined gestural expressions within the visual sensor data. The system is configured to provide a display control signal to a display 30 of the vehicle, to cause the display to show a visual representation of the detected gestural expression. The system is configured to determine the information on the feedback to the stimulus based on the detected gestural expression.

FIG. 1c shows a flow chart of an embodiment of a corresponding method for determining information on a feedback to a stimulus (within a vehicle). The method comprises obtaining 110 visual sensor data from an optical sensor of the vehicle. The visual sensor data depicts at least a face of a user of the vehicle. The method comprises processing 120 the visual sensor data to detect one of a plurality of pre-defined gestural expressions within the visual sensor data. The method comprises providing 130 a display control signal to a display of the vehicle, to cause the display to show a visual representation of the detected gestural expression. The method comprises determining 140 the information on the feedback to the stimulus based on the detected gestural expression.

The following description relates both to the system of FIGS. 1a and/or 1b and to the corresponding method. Features described in connection with the system 10 and the vehicle/device 100 of FIGS. 1a and/or 1b may be likewise applied to the method of FIG. 1c.

Embodiments of the present disclosure relate to a system, a method and a computer program for determining information on a feedback to a stimulus. As has been laid out in the introductory part of the present disclosure, in vehicles, as in other situations, feedback may be desired on stimuli that are generated by the respective vehicle or device. For example, in a vehicle, the mirrors may be automatically adjusted to a new driver, e.g. based on their height, and feedback may be required that relates to that change. In this case, the change of the mirror may be a stimulus, and feedback may be desired that indicates whether the new driver is content with the change. In some other cases, the stimulus may be the change to more ergonomic seating position, the adjustment of a lighting system of the vehicle, the adjustment of a music selection, or the dissemination of a scent within the vehicle. In these cases, the driver, or other passengers (further denoted by the term “user” or “passenger”, which include both the driver and the other passengers) may provide feedback on the stimulus, indicating whether they agree to the change. To reduce a distraction caused by the feedback-giving, in embodiments, the feedback is generated based on the gestural expression of the user. In other words, the system is suitable for, or configured to, to determine feedback to the stimulus based on the gestural expression of the user. In the context of this disclosure, the gestural expression may be or include a facial gestural expression, in short, a facial gesture. In some embodiments, the gestural expression may comprise one or more further components, in addition to the facial gesture, such as a hand gesture, a posture or a heart rate of the user. There may be different types of stimuli. For example, the stimulus may be one of an auditory stimulus, a visual stimulus, an olfactory stimulus, a tactile or haptic stimulus and a vehicle climate stimulus, these being different types of stimuli. In some embodiments, the stimulus may comprise two or more distinctive components, e.g. two or more of an auditory stimulus component, a visual stimulus component, an olfactory stimulus component, a tactile or haptic stimulus component and a vehicle climate stimulus component. In this case, the multi-component stimulus may have multiple types. Stimuli with multiple components may provide or correspond to an “experience”. In general, and in this context, the stimulus or stimuli may originate from within the vehicle. For example, the stimulus or stimuli may be generated by a stimulus generation device of the vehicle.

The system is configured to obtain (e.g. receive or read-out) the visual sensor data from an optical sensor 20 of the vehicle. In general, the optical sensor 20 may comprise an APS (Active Pixel Sensor)—or a CCD (Charge-Coupled-Device)-based imaging sensor. For example, in APS-based imaging sensors, light is recorded at each pixel using a photodetector and an active amplifier of the pixel. APS-based imaging sensors are often based on CMOS (Complementary Metal-Oxide-Semiconductor). In CCD-based imaging sensors, incoming photons are converted into electron charges at a semiconductor-oxide interface, which are subsequently moved between capacitive bins in the imaging sensor modules by a control circuitry of the sensor imaging module to perform the imaging. Alternatively, or additionally, the optical sensor 20 may be a depth-sensing camera or comprise a depth sensor, suitable for providing depth-sensing visual sensor data. Accordingly, the visual sensor data may be a depth-sensing visual sensor data or comprise a two-dimensional and a depth-sensing component. For example, the optical sensor 20 may comprise a depth sensor, e.g. a Time of Flight-based depth sensor or a structured light-based depth sensor. The visual sensor data may comprise two-dimensional camera image data and/or three-dimensional camera image data. The visual sensor data may be obtained by receiving the visual sensor data from the optical sensor (e.g. via the interface 12), by reading the visual sensor data out from a memory of the optical sensor (e.g. via the interface 12), or by reading the visual sensor data from a storage device 16 of the system 10, e.g. after the visual sensor data has been written to the storage device 16 by the optical sensor or by another system or processor.

The visual sensor data depicts (e.g. show) at least a face of a user of the vehicle. For example, the visual sensor data may comprise an image (e.g. a two-dimensional image or a three-dimensional representation) of the face of the user of the vehicle, or of an upper portion of the body comprising the face. Accordingly, the optical sensor 20 may be directed at the face of the user. For example, the optical sensor may be arranged within a dashboard or within a rearview mirror or side-mirror component of the vehicle, or within a headrest of the vehicle (for users in the backrow of the vehicle).

The system is configured to process the visual sensor data to detect one of a plurality of predefined gestural expressions within the visual sensor data. In other words, the system may be configured to apply image processing on the visual sensor data, and to use the image processing to detect one of the plurality of pre-defined gestural expressions within the visual sensor data. The system may use one or more image processing algorithms to detect the gestural expression within the visual sensor data. Alternatively, the system may be configured to use a pre-trained gesture detection machine-learning model to detect the gestural expression within the visual sensor data. For example, the visual sensor data may be used as an input to the pre-trained gesture detection machine-learning model, and the detected gestural expression may be provided as an output of the pre-trained gesture detection machine-learning model. In any case, the system may be configured to categorize the gestural expression of the user shown in the visual sensor data in one of the plurality of pre-defined gestural expressions. Either way, the system may use a publicly available framework, such as the Affectiva framework, to detect the gestural expression.

In general, the system is configured to provide the display control signal to a display 30 of the vehicle, to cause the display to show a visual representation of the detected gestural expression. The visual representation of the detected gestural expression may be used to make the user aware that their gestural expression is being detected and used to determine feedback on the stimulus. The visual representation of the detected gestural expression may also act as a playful training of the user, to incite the user to provide a discernible gestural expression for the optical sensor.

In at least some embodiments, the user may be made aware that feedback is being determined, by prompting the user to provide a gestural expression. In other words, the system may be configured to provide a prompt to the user via an output device of the vehicle. For example, the prompt may be provided to the user via at least one of the display 30 (e.g. a dashboard display or a projection-based head-up display), a sound device 40 (e.g. a loudspeaker), a haptic or tactile output device 40 (e.g. a vibrational output device) and a lighting system 40 e.g. ambient lights) of the vehicle. Accordingly, the output device may be one of the display 30, the sound device 40, the haptic or tactile output device 40 and the lighting system 40 of the vehicle. In FIG. 1b, a generic output device 40 is shown, which may also be used as a stimulus generation device 40.

The prompt may invite (i.e. instruct or make aware) the user to provide gestural feedback, e.g. one of the plurality of pre-defined gestural expressions, in response to the stimulus. In other words, the system may be configured to provide the prompt such, that the user is made aware of the recording and detection of their gestural expression. As the detection of the gestural expression is performed with reference to the stimulus, the prompt may also be provided around the time the stimulus occurs. For example, the stimulus may occur (e.g. start or be triggered) at a (specific) point in time. The prompt may be provided such, that the prompt to provide gestural feedback is perceptible during a pre-defined period relative to the point in time the stimulus occurs at. For example, the prompt may be provided during a pre-defined period before and/or after the point in time. The pre-defined period may be chosen such, that the user is provided with a chronological connection between the stimulus and the prompt. For example, the prompt may be shown (e.g. may begin to be shown) at a pre-defined point in time relative to the start of the stimulus, e.g. at a pre-defined point in time before the start of the stimulus, or at a pre-defined point in time after the start of the stimulus. In both cases, the point in time may be chosen such, that the user makes a logical connection between the stimulus and the prompt.

In various embodiments, the system may be configured to provide the prompt such that it mimics the stimulus, e.g. in order to make a more obvious connection between the stimulus and the prompt. In other words, the system may be configured to generate a representation of the stimulus, and to provide the prompt with the representation of the stimulus to the user. For example, if the stimulus comprises a light component provided via the lighting system of the vehicle, the prompt may be shown with the same color or colors of the light component. In some embodiments, a modal analogon may be chosen for the prompt based on the stimulus, e.g. a color that represents a sound or a smell (e.g. blue for a relaxed sound, or yellow for a citrusy smell). In various embodiments, the prompt may be a multi-modal prompt (i.e. may be provided via a plurality of different output devices), e.g. at a sub-liminal level, in order to reduce a distraction of the user. Again, the system may be configured to provide the prompt such that it mimics the stimulus by selecting two or more output devices based on the type of the stimulus. In other words, the system may be configured to select one, or multiple, of a plurality of output devices for the prompt based on the type of the stimulus, e.g. in order to mimic the stimulus.

In some embodiments, the prompt may be provided on a subliminal level, or out of sight of the user, or the user may be concentrated on driving, on a conversation or on a book or movie, so that the user does not react to the prompt. In this case, the prompt may be repeated using another output device. Accordingly, the system may be configured to monitor a response of the user to the prompt by processing the visual sensor data. For example, the system may be configured to determine whether a response of the user to the prompt (and the stimulus) is discernible. For example, a response to the prompt may be deemed discernible, if the user changes their gestural expression in response to the prompt, of if the user retains their gestural expression (that is different from a base-line gestural expression of the user) for a pre-defined period relative to the prompt or relative to the stimulus. If no response to the prompt can be discerned, the prompt may be repeated, e.g. via the same output device or via another output device. In other words, the system may be configured to repeat the prompt using the same or using another output device in case of a lack of a response.

The system is configured to provide a display control signal to the display 30 of the vehicle (e.g. via the interface 12), to cause the display to show the visual representation of the detected gestural expression. In general, the visual representation may mirror the gestural expression of the user, e.g. the detected gestural expression. In other words, the visual representation may be a real-time (or near-real-time) visual representation of the gestural expression of the user. The system may be configured to (continuously) update the display control signal to provide a real-time visual representation of the gestural expression of the user. The visual representation may behave like a real-time “Digital Mirror”.

In some embodiments, the visual representation of the gestural expression of the user may be shown at any time, e.g. to allow an identification of the user with the visual identification. In some other embodiments, however, the visual representation may be used more sparingly, e.g. (only) when feedback is to be provided, and/or when the system is being trained to detect the gestural expression of the user (and vice versa), e.g. at as an initial setup or calibration stage—for example when a user is new to a vehicle or new to an aspect of an experience (e.g. for scent experience, a user might receive a new palette of scents, and the user may be taken through an initial calibration exercise to evaluate their nose sensitivity and preferences (likes/dislikes) by delivering a scent and asking them to respond.

In both cases, the visual representation may be shown at a point in time relative to the point in the stimulus occurs at. In other words, the display control signal may be provided such, that the visual representation of the detected gestural expression is shown during a pre-defined period of time relative to the point in time the stimulus occurs at, e.g. before and/or after the point in time the stimulus occurs at. For example, the visual representation (and thus the prompt) may be provided during a pre-defined period before and/or after the point in time. In this case, the visual representation may be used as prompt to provide feedback on the stimulus.

In general, there are various ways of representing the gestural expression. It might be detrimental to show the actual face of the user as representation of the gestural expression, as this might not provide an accurate representation of the gestural expression being detected by the system, but image data of the face of the user may be provided in addition to the visual representation of the gestural expression. Consequently, the visual representation may show an abstract representation of the detected gestural expression. For example, the visual representation may be an avatar—e.g. emoji, cartoon, abstracted, stylized or realistic avatar, etc. In other words, the visual representation may be based on one of an avatar of the user, an emoji and a visual icon. In some embodiments, a partial avatar may be used (e.g. eyes and mouth) overlaying the live (video) image of the user. In other words, an abstract representation of the detected gestural expression may be overlaid over the visual sensor data of the face of the user, and may replace or overlay the eyes and the mouth of the user.

Additionally or alternatively, the detected gestural expression may be shown as a position on a scale. For example, the abstract representation of the detected gestural expression (e.g. the avatar, smiley, icon etc.) may be shown above or on the scale, representing the gestural expression relative to the scale. This may be used to instruct the user as to the connotations of the gestural expressions—e.g. to indicate whether raised eyebrows are seen as positive or negative on the scale. In general, the scale may represent to the feedback being determined based on the detected gestural expression.

The system is configured to determine the information on the feedback (i.e. the feedback) to the stimulus based on the detected gestural expression. In other words, the system may be configured to determine feedback in response to the stimulus, the feedback being provided by the user. The user may give feedback in response to the stimulus through their gestural expression. The feedback may be determined at or around the time the stimulus occurs (e.g. starts). For example, the information on the feedback to the stimulus may be determined based on the detected gestural expression that is based on visual sensor data of a pre-defined period of time relative to the point in time the stimulus occurs. For example, while the detection of the gestural expression may be performed for a longer period of time, e.g. all the time, or before and after the occurrence of the stimulus, only the visual sensor data of a pre-defined period of time relative to the point in time the stimulus occurs might be used to determine the feedback. Even then, only the detected gestural expression that is shown the longest (or at the end of the period of time) might be used to determine the gestural expression. In other words, the system may be configured to determine a gestural expression that is detected longest during the pre-defined period of time. For example, the pre-defined period of time the determination of the feedback is based on may intersect with or correspond to the pre-defined period of time the prompt is provided. Thus, the feedback may be determined based on the gestural expression (or gestural expressions) performed by the user the (entire) time the prompt is shown, or the feedback may be determined based on the gestural expression performed by the user at the time the pre-defined period ends. In this case, a (visual or auditory) countdown may be provided as part of the prompt.

In various embodiments, the system may be configured to monitor a response of the user to the stimulus via the visual sensor data. For example, the system may determine whether the user response (i.e. shows a reaction) to the prompt (and/or the stimulus) based on the visual sensor data. The system may be configured to determine the information on the feedback to the stimulus if a response to the stimulus is discernible.

Different users may have different ranges of gestural expressions. For example, some user may be expressive with their gestural expressions, while other users may show only a limited range and intensity (i.e. expressiveness) within their gestural expressions. Accordingly, the system may be configured to calibrate the detection of the gestural expressions and the determination of the feedback to the user. For example, the system may be configured to process the visual sensor data before the stimulus occurs to determine a base-line gestural expression of the user. For example, the base-line gestural expression may be determined during a calibration phase of the system (e.g. when the respective user first uses the system), or (directly) before the stimulus occurs. The base-line gestural expression may represent a gestural expression that the user returns to after stimulation or between stimulations. The system may be configured to determine the information on the feedback to the stimulus relative to the baseline gestural expression of the user.

In some embodiments, additional biometric information may be considered when determining the feedback on the stimulus. For example, users may generally use their whole bodies to express emotions (e.g. nodding or shaking their head, looking down/away, etc.). Accordingly, the visual sensor data may show more than just the face (e.g. the upper portion of the body), and the system may be configured to determine the gestural expression based on the visual sensor data of the upper portion of the body. Additionally or alternatively, visual sensor data of the same or of another optical sensor may be used to determine one or more further physical indicators of the user's body, and to determine the feedback thereupon. In other words, the system may be configured to monitor one or more further physical indicators of the user's body within the visual sensor data or within additional sensor data. For example, the additional sensor data may be visual sensor data of another camera sensor, sensor data of a heart rate sensor, microphone sensor data etc. In some embodiments, the system may be configured to obtain the additional sensor data from a device that is external to the vehicle, e.g. from a mobile device, wearable device or heart rate monitor of the user. The system may be configured to determine the information on the feedback to the stimulus based on the monitored one or more further physical indicators. Thus, other data sources, from the vehicle or other devices (e.g. smartphones and smartwatches) may be combined. For example, the additional sensor data may comprise bio-signals such as heart rate data (which can indicate arousal, stress, etc.).

In general, the system may be configured to derive the feedback from the detected gestural expression. For example, the system may be configured to determine a numerical value (e.g. on a scale) based on the detected gestural expression. For example, gestural expressions with negative connotations (e.g. a sad, disgusted or angry gestural expression) may be represented as a low or negative number, gestural expressions with positive connotations (e.g. a smile) may be represented as high and/or positive numbers, and/or gestural expressions with neutral connotations (e.g. a poker face) may be represented as a neutral number (e.g. between low and high numbers, such as 50 on a scale from 0 to 100, or as zero). Alternatively, the system may be configured to derive a binary value (e.g. “good feedback”, “bad feedback”) or a ternary value (e.g. “good feedback”, “bad feedback” or “neutral feedback”) from the gestural expression. The information on the feedback may comprise at least one of the numerical value, the binary value, the ternary value and a string or value representing the detected gestural expression.

In various embodiments, the system might not only be used to evaluate the response to the stimulus, but also to trigger and/or adjust the stimulus/stimuli. In other words, the system may be configured to provide a control signal to a stimulus generation device 30; 40 of the vehicle, to trigger or adjust the stimulus or stimuli. As laid out before, the stimulus may be one of an auditory stimulus, a visual stimulus, an olfactory stimulus, a tactile or haptic stimulus and a vehicle climate stimulus. Accordingly, the system may be configured to trigger or adjust the stimulus or stimuli using one or more of the display 30, the sound device 40, the haptic or tactile output device 40, the lighting system 40 and a vehicle climate system of the vehicle.

For example, the stimulus may comprise two or more distinctive components. Accordingly, the system may be configured to adjust the stimulus or stimuli via two or more distinctive stimulus generation devices/output devices of the vehicle. The system may be configured to determine the information on the feedback to the stimulus after triggering or adjusting the stimulus or stimuli.

In various embodiments, the information and the feedback may be stored, together with information on the respective stimulus, by the system, e.g. using the one or more storage devices. For example, the information may be stored using discrete capturing of data (e.g. at specific points in time) and continuous capturing of data (continuously over a period of time), or a combination of both. Based on the stored information, a prediction model may be generated, which enables a prediction of the feedback for a given stimulus (or given stimuli). For example, the system may be configured to train a machine-learning model using information on the stimulus as a training input and the information on the feedback as a desired output of the machine-learning model.

Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model.

Machine-learning models are trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. In the context of the present disclosure, information on the stimulus may be used as training input data (e.g. as training samples), and the information on the feedback may be used as desired output values.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge, e.g. based on the training performed by the machine-learning algorithm. In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input. In at least some embodiments, the machine-learning model may be deep neural network, e.g. a neural network comprising one or more layers of hidden nodes (i.e. hidden layers), prefer-ably a plurality of layers of hidden nodes.

Alternatively, the machine-learning model may be a support vector machine. Support vector machines (i.e. support vector networks) are supervised learning models with associated learning algorithms that may be used to analyze data, e.g. in classification or regression analysis. Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

The machine-learning model may be trained such, that that the machine-learning model is suitable for predicting the information on the feedback for a given stimulus. In other words, the machine-learning model may be trained to provide an estimated feedback for a stimulus for an input comprising information on the stimulus.

For example, the system may be configured to provide the control signal to the stimulus generation device based on an output of the machine-learning model. For example, the system may be configured to use the machine-learning model to predict a feedback of the user to a plurality of stimuli, and to select one of the stimuli for the user based on the output of the machine-learning model.

In some embodiments, the machine-learning model, or the information being used to train the machine-learning model, may be provided to a server that is external to the vehicle, e.g. via the interface 12. The provided information may be used to discern trends regarding the feedback to the stimuli over multiple users.

The above embodiments have been directed at a system, method and computer program for use in a vehicle. The general idea of the present disclosure, however, may also be used in other contexts, e.g. with mobile devices (e.g. smartphones, wearable devices), televisions, set-top boxes etc. Accordingly, the above embodiments may be adopted to other kinds of devices. Therefore, the above concepts are now presented in more generic terms. Embodiments may further provide a system 10 for determining information on a feedback to a stimulus provided by a device 100. For example, the device may be one of a mobile device (e.g. a smartphone, a wearable device), a television, and a set-top box. The system comprises the one or more processors 14 and the one or more storage devices 16.

The system is configured to obtain visual sensor data from an optical sensor 20 of the device. The visual sensor data may depict at least a face of a user of the device. Accordingly, instead of the optical sensor of the vehicle, in more generic terms, an optical sensor of the device may be used, such as a front-facing camera of a smartphone, a camera of a set-top box or of a television etc.

The system may be configured to process the visual sensor data to detect one of a plurality of pre-defined gestural expressions within the visual sensor data. The system may be configured to provide the display control signal to a display of the device, to cause the display to show a visual representation of the detected gestural expression. For example, the display of the device may be the display of the smartphone or of the smartwatch, the display of the television or of a television being connected to the set-top box. This display may also be used to show the prompt. Alternatively, a loudspeaker of the device (or of the television being connected to the device) to provide the prompt to the user. The system may be configured to determine the information on the feedback to the stimulus based on the detected gestural expression. Again, the system may be configured to provide the stimulus via a stimulus generation device (e.g. a display, loudspeaker, vibration motor, backlighting etc.) of the device.

For the sake of completeness, embodiments of the present disclosure may further provide a method for determining information on a feedback to a stimulus provided by a device. The method may comprise obtaining 110 visual sensor data from an optical sensor of the device, the visual sensor data depicting at least a face of a user of the device. The method may comprise processing 120 the visual sensor data to detect one of a plurality of pre-defined gestural expressions within the visual sensor data. The method may comprise providing 130 a display control signal to a display of the device, to cause the display to show a visual representation of the detected gestural expression. The method may comprise determining 140 the information on the feedback to the stimulus based on the detected gestural expression.

The interface 12 may correspond to one or more inputs and/or outputs for receiving and/or transmitting information, which may be in digital (bit) values according to a specified code, within a module, between modules or between modules of different entities. For example, the interface 12 may comprise interface circuitry configured to receive and/or transmit information. In embodiments the one or more processors 14 may be implemented using one or more processing units, one or more processing devices, any means for processing, such as a processor, a computer or a programmable hardware component being operable with accordingly adapted software. In other words, the described function of the one or more processors 14 may as well be implemented in software, which is then executed on one or more programmable hardware components. Such hardware components may comprise a general-purpose processor, a Digital Signal Processor (DSP), a micro-controller, etc. In at least some embodiments, the one or more storage devices 16 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage. For example, the vehicle 100 may be a land vehicle, a road vehicle, a car, an automobile, an off-road vehicle, a motor vehicle, a truck or a lorry.

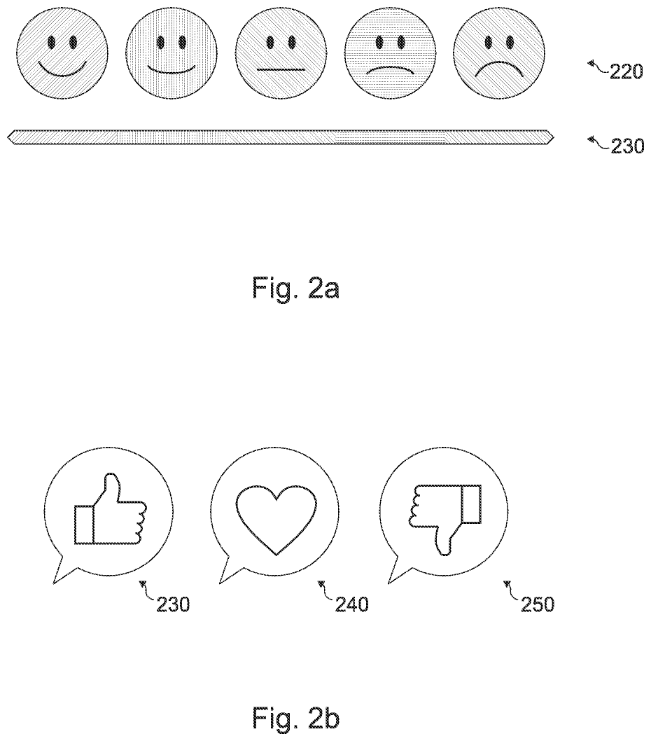

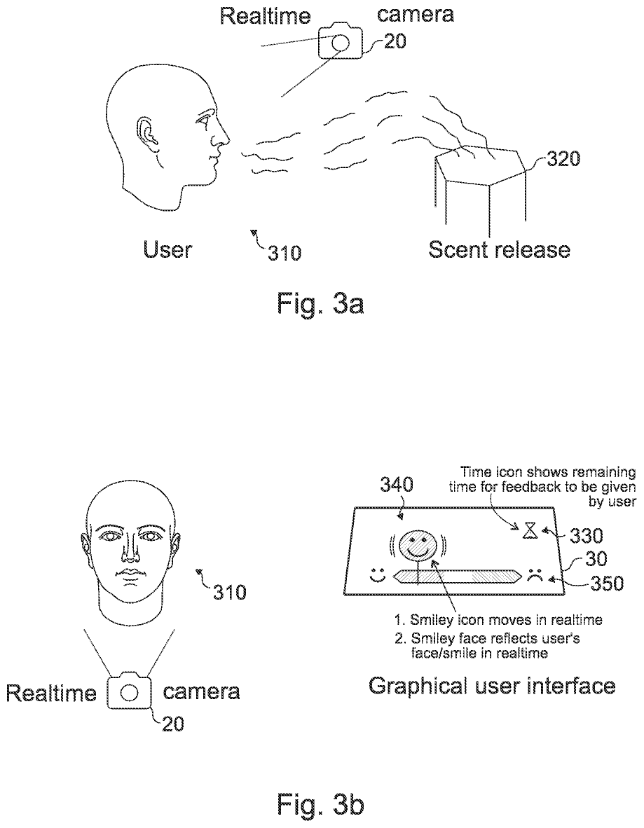

More details and aspects of the system, method and computer program are mentioned in connection with the proposed concept or one or more examples described above or below (e.g. FIGS. 2a to 3b). The system, method and computer program may comprise one or more additional optional features corresponding to one or more aspects of the proposed concept or one or more examples described above or below.

Gathering user feedback can be interaction-intensive, disruptive, and may be perceived negatively over time. Motivating users to provide feedback may be a barrier, and designing systems that consider a low level of user motivation may be desired.

Typically in today's vehicles, users make manual choices over cabin features they would like to use (e.g. turning buttons on/off). When more sophisticated experiences are created, such as holistic, multi-sensory experiences, the curation of the experience may become more complex, such that if a human user was asked to manually control the experience, they might quickly be overwhelmed by User Interface (UI) menus and choices. Automating the experience of elements of the experience may be beneficial for a premium experience.

This automation may use intelligent experiences where predictions and assumptions may be made (based on accurate context data, and good data interpretation) over the desired preferences of the user, and what is relevant and meaningful for them as a premium experience.

Therefore the intelligent system may benefit from feedback from the user, in real-time or at various or key moments during an experience, to evaluate the success of the experience; e.g. does it suit the user's preferences and is it relevant and meaningful them? With this information, the system can learn and improve over time, using machine learning and artificial intelligence. And, what it learns from one user or a group of users can be applied to future users, and contextually filtered according to demographic, region, culture, etc.

Gathering subjective feedback, and reading human affect, emotions and expressions has often been difficult and expensive. Now, ubiquitous cameras, machine learning and artificial intelligence based technologies enable systems to read human affect, emotions and expressions with greater accuracy, unobtrusively and cost effectively. For example, embodiments may use real-time facial gesture recognition with video camera, machine learning and artificial intelligence technologies.

At least some embodiments of the present disclosure provide real-time facial gesture input. Real-time facial gesture and facial emotion detection technology may be used as a new interaction modality that may be combined with a graphical user interface and/or speech interface. Real-time facial gesture and facial emotion detection technology may be especially suited to multi-sensory experiences that have a more intangible or subjective element to the experience.

At least some embodiments are based on an analysis of facial features to evaluate user affect, emotion, expressions or facial features over time, e.g. in real-time. For example, embodiments may use a categorization of real-time facial features against an affective metric; for example according to valence (attractiveness/aversiveness, happy/sad, like/dislike, etc.) or arousal (e.g. intensity, magnitude, etc.) Embodiments may further use a real-time visualization (e.g. the visual representation of the detected gestural expression) showing the user's state for that affective metric. For example, the visualization can show the current or average state dynamically in real-time, and/or show a final state at a key point in time (e.g. at the end of a time window for user feedback).

In various embodiments, the affective feedback may be aggregated relative to the user and vehicle context, and artificial intelligence and machine learning may be applied to improve future experiences by learning about the user's preferences and what's relevant and meaningful relative to the user and vehicle context. In some embodiments, this data may be crowdsourced and anonymized to curate or improve future experiences for groups of users or customize experiences for specific users or subsets of users. Various embodiments may be combined with other facial detection/recognition approaches, such as facial recognition (identification) or eye/gaze tracking (focus of sight), and/or with other means related to bio-feedback, entrainment (e.g. slow breathing control), behavior (e.g. gamification of behavior), etc.

For example, facial gesture input (e.g. the detected gestural expression) for “bio-feedback” on whether a user likes or dislikes an experience or an element of an experience (i.e. a stimulus) may be used by the system. The user might be the driver and/or passenger, in a conventional car, On-Demand Mobility (ODM) or future autonomous vehicle. A camera (i.e. an optical sensor) may monitor the user's facial expression; this could be a dedicated camera or an existing camera such as the distraction/inattention camera or video conferencing camera.

For example, the system can pose a specific “question” (i.e. the prompt) at a key moment—the system may look for an affective response over a window of time (e.g. window in the GUI (Graphical User Interface) is active for a certain period of time, and/or a countdown timer shows that the system is “open for feedback”, and/or like a “timed photo” or video). This “question/prompt” can be posed via the GUI as text and/or graphics/iconography or via voice (e.g. the Intelligent Personal Assistant (IPA) asks a question). Alternatively, or additionally, the system may observe the user over an extended period of time relative to a key moment to assess the user's average affective state. The user may register some feedback by acknowledging the moment by a facial gesture, holding a facial gesture or touch gesture (e.g. relative to a GUI or ambient interface, such as the ambient interface of an olfactory system).

The system may run in parallel real-time, and display the user's affective state as a visualization on a graphical user interface. The user may receive “live” feedback on their facial gesture/expression; such that when the user's smile changes the visualization mirrors that change in smile, dynamically in real-time. By doing this, the user may build a mental model of the interaction as a 1:1 interaction between facial gesture and visualization. This has the effect to create a feeling of interactivity that is playful and gamifies the feedback process. For example, visualization (i.e. the visual representation of the detected gestural expression) can be abstracted like an avatar, emoticon or icon (e.g. easily understood and universal icons such as a smiley face, thumbs up, heart, etc.) The visualization might include an absolute or relative scale for the affective metric (e.g. like/dislike, happy/sad, etc.). The system may evaluate the user's affective state and record the results as discrete or time-based data. The results can be used to influence or predict future experiences (such weighting, prioritizing, promoting or eliminating elements of an experience) and/or add to a data library that informs the system (and/or other systems) about the user and their preferences.

In embodiments, the facial gestures of the user may be evaluated on one or more scales/metrics, such as “valence” (a measure of the positive or negative nature of the stimulus triggering the facial gesture) or “engagement” (a measure of facial muscle activation that indicates the expressiveness of the facial gesture). For example, the valence metric may be calculated based on a set of observed facial expressions. For example, a more positive metric may be indicated by a smile or a cheek raise, and a more negative metric by an inner brow raise, a brow furrow, a nose wrinkle, an upper lip raise, a lip corner depression, a chin raise, a lip press or a lip suck. Engagement or expressiveness may be seen as a (weighted) combination of the above facial gestural expressions.

The detected gestural expressions may be mapped to emotions. For example, the observed facial expressions as input to calculate the likelihood of an emotion, e.g. based on the Emotional Facial Action Coding System developed by Friesen & Ekman. A facial expression can have either a positive or a negative effect on the likelihood of an emotion. For example, for the emotion “Joy”, the facial gesture “smile” may increase the likelihood, and a “brow raise” or a “brow furrow” may decrease the likelihood. For “disgust”, a “nose wrinkle” may increase the likelihood, and a “smile” may decrease the likelihood etc. In embodiments, the emotions “Joy” and “Disgust”, but also the emotions “Anger”, “Surprise”, “Fear”, “Sadness” or “Contempt” may be used as feedback in the stimulus. For example, in embodiments one or more facial gestural expressions of the group of inner/outer brow raise, jaw drop, lid tighten, lip corners depressed, brow furrow, brow raise, cheek raise, chin raise, dimples (corners of the lips pulled inwards), eye closure and eye wide may be used.

Real-time detection of facial gestures may be used to control user interfaces. In embodiments, the detected gestural expression may be presented to the user using a visual representation of the gestural expression, e.g. via an emoji. For example, an emoji may be controlled with the user's face and it may be used as an input to a graphical user interface. For example, embodiments may provide real-time facial gesture recognition via camera-based analysis (e.g. using a framework). For example, emojis such as Laughing, Smiley, Relaxed, Wink, Kissing, Stuck Out Tongue, Stuck Out Tongue and Winking Eye, Scream, Flushed, Smirk, Disappointed, Rage, or Neutral may be used to represent the detected gestural expression. Alternatively, as shown in FIG. 2a, a scale 210 may be used, and a smiley 220 may be placed on the scale, and/or transformed to represent a point on the scale. In FIG. 2a, an interpretation/visualization across a scale is shown (e.g. like to dislike), in FIG. 2b an interpretation/visualization as discrete states (e.g. limited to 2 or 3 states) is shown, such as a thumbs-up 230, a heart 240 or a thumbs down 250. FIGS. 2a and 2b show exemplary visual representations of a gestural expression of a user.

Embodiments may thus use real-time “bio-feedback”. For interpretation (i.e. as an output), a real-time interpretation may be displayed as “bio-feedback” to user (i.e. the visual representation of the detected gestural expression). Facial gestures may be categorized into discrete values, e.g. for valence: like/dislike or attractiveness/aversiveness. Embodiments may provide a real-time display of like or dislike via a graphical user interface (i.e. the visual representation of the detected gestural expression). The user may adapt or exaggerate the facial expression to reach their desired statement. This may result in a fun and playful interface. The facial gesture input may eliminate/alleviate the need for a touch or voice input of feedback.

In the following, the application of the concept to the field of “olfactory stimuli” in vehicles is shown. In other words, the stimulus may be or comprise a scent/smell. In a simple initial setup or calibration, this approach may be used to evaluate the sensitivity of a user's sense of smell. This approach may also be used periodically or upon change (e.g. when a new scent blend is released) to evaluate the user's likes and dislikes, e.g. and to build a preference model for future customization and crowd source preferences to understand the popularity of different scents, and how to improve future scent palettes for all customers.

An evaluation of user likes/dislikes may be performed for each scent or scent blend. The evaluation (i.e. the generation of the information on the feedback) may be performed either in normal use, initial setup, calibration or periodically. The evaluation/feedback may be used as an input for a machine learning process.

FIGS. 3a and 3b shows an exemplary application of the concept. FIGS. 3a and 3b shows an example of a determination of information on a feedback to a scent-based stimulus. In FIG. 3a, a real-time camera 20 takes a picture of a user 310, upon release of a scent of a scent generation device 320. In FIG. 3b, the picture (or frame) is taken by the real-time camera (operating at n frames per second (fps), e.g. 30 fps), the picture depicting a gestural expression of the user, and a real-time representation of the gestural expression is shown in a graphical user interface on a display 30. On the display, three elements may be shown—a timer 330, a smiley 340, and a scale 350. The timer (or some graphical device to indicate remaining time and/or progress and/or running status, implicit or explicitly) may indicate a time period or a point in time when the feedback is generated, e.g. the time remaining for feedback to be given by the user. The smiley 340 may move along the scale 350 in real-time, according to the detected gestural expression. The smiley face of smiley 340 may reflect the user's face/smile in real-time. For example, the scale may be colored, e.g. ranging from green for positive feedback to red for negative feedback.

In embodiments, the camera may read a facial expression (e.g. a smile). The system may interpret and categorize the expression, and may provide feedback in real-time. The user may continually update the expression—which will be fun and playful, and easily learned with familiarity. For example, the (gestural) expression can be captured as a “timed photo or when the user holds the expression for a set period of time (e.g. 1 sec.).

Embodiments may be used for future intelligent experiences that benefit from feedback from the user, e.g. holistic, multi-sensory or multi-modal experiences, similar to the above scent generation device. Applications outside of the vehicle cabin are also feasible, e.g. for the evaluation of customer service, website engagement, etc., and outside the automotive industry, e.g. future aviation experiences, mobile or smart devices (e.g. smartphones, tablets, etc.), etc. Embodiments may also be used with Consumer Electronic smart devices.

More details and aspects of the concept are mentioned in connection with the proposed concept or one or more examples described above or below (e.g. FIGS. 1a to 1c). The concept may comprise one or more additional optional features corresponding to one or more aspects of the proposed concept or one or more examples described above or below.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

What is claimed is:

1. System for determining information on a feedback to a stimulus provided by a device, the system comprising one or more processors and one or more storage devices, wherein the system is configured to:
obtain visual sensor data from an optical sensor of the device, the visual sensor data depicting at least a face of a user of the device;
process the visual sensor data to detect one of a plurality of pre-defined gestural expressions within the visual sensor data;
provide a display control signal to a display of the device, to cause the display to show a visual representation of the detected gestural expression; and
determine the information on the feedback to the stimulus based on the detected gestural expression.

2. The system according to claim 1, wherein the device is a vehicle, and wherein the system is suitable for determining information on a feedback to a stimulus within the vehicle.

3. The system according to claim 1, wherein the stimulus occurs at a point in time, and wherein the display control signal is provided such, that the visual representation of the detected gestural expression is shown during a pre-defined period of time relative to the point in time,
and/or wherein the information on the feedback to the stimulus is determined based on the detected gestural expression that is based on visual sensor data of a pre-defined period of time relative to the point in time.

4. The system according to claim 1, wherein the system is configured to provide a prompt to the user via an output device of the device or vehicle, the prompt inviting the user to provide gestural feedback in response to the stimulus.

5. The system according to claim 4, wherein the prompt is provided such, that the prompt to provide gestural feedback is perceptible during a pre-defined period relative to a point in time the stimulus occurs at.

6. The system according to claim 4, wherein the system is configured to select one of a plurality of output devices for the prompt based on a type of the stimulus, and/or wherein the system is configured to generate a representation of the stimulus, and to provide the prompt with the representation of the stimulus to the user.

7. The system according to claim 4, wherein the system is configured to monitor a response of the user to the prompt by processing the visual sensor data, and to repeat the prompt using another output device in case of a lack of a response.

8. The system according to claim 1, wherein the system is configured to process the visual sensor data before the stimulus occurs to determine a base-line gestural expression of the user, and to determine the information on the feedback to the stimulus relative to the base-line gestural expression of the user.

9. The system according to claim 1, wherein the visual representation is based on one of an avatar of the user, an emoji and a visual icon,
and/or wherein the detected gestural expression is shown as a position on a scale.

10. The system according to claim 1, wherein the system is configured to provide a control signal to a stimulus generation device of the device or vehicle, to trigger or adjust the stimulus or multiple stimuli, and to determine the information on the feedback to the stimulus after triggering or adjusting the stimulus or stimuli.

11. The system according to claim 1, wherein the stimulus is one of an auditory stimulus, a visual stimulus, an olfactory stimulus, a tactile or haptic stimulus and a vehicle climate stimulus,
and/or wherein the stimulus comprises two or more distinctive components.

12. The system according to claim 1, wherein the system is configured to monitor a response of the user to the stimulus via the visual sensor data, and to determine the information on the feedback to the stimulus if a response to the stimulus is discernible.

13. The system according to claim 1, wherein the system is configured to monitor one or more further physical indicators of the user's body within the visual sensor data or within additional sensor data, and to determine the information on the feedback to the stimulus based on the monitored one or more further physical indicators.

14. The system according to claim 1, wherein the system is configured to train a machine-learning model using information on the stimulus as a training input and the information on the feedback as a desired output of the machine-learning model, such that the machine-learning model is suitable for predicting the information on the feedback for a given stimulus.

15. Method for determining information on a feedback to a stimulus provided by a device, the method comprising:
obtaining visual sensor data from an optical sensor of the device, the visual sensor data depicting at least a face of a user of the device;
processing the visual sensor data to detect one of a plurality of pre-defined gestural expressions within the visual sensor data;
providing a display control signal to a display of the device, to cause the display to show a visual representation of the detected gestural expression; and
determining the information on the feedback to the stimulus based on the detected gestural expression.

16. The method according to claim 15, wherein the device is a vehicle, and wherein the method is suitable for determining information on a feedback to a stimulus within the vehicle.

17. A computer program product comprising a computer readable medium having computer readable program code embodied therein, the computer readable program code being configured to implement a method for determining information on a feedback to a stimulus provided by a device, the method comprising:
obtaining visual sensor data from an optical sensor of the device, the visual sensor data depicting at least a face of a user of the device;
processing the visual sensor data to detect one of a plurality of pre-defined gestural expressions within the visual sensor data;
providing a display control signal to a display of the device, to cause the display to show a visual representation of the detected gestural expression; and
determining the information on the feedback to the stimulus based on the detected gestural expression.
